(19) United States
(12) Patent Application Publication
(10) Pub. No.: US 2015/0220112 A1
(43) Pub. Date: Aug. 6, 2015

(54) First and Second Housing and A Mass Storage Device

(71) Applicants: Lee Warren Atkinson, Houston, TX (US); Norman P Brown, Tomball, TX (US); Mark Erby Taylor, Houston, TX (US)

(72) Inventors: Lee Warren Atkinson, Houston, TX (US); Norman P Brown, Tomball, TX (US); Mark Erby Taylor, Houston, TX (US)

(21) Appl. No.: 14/384,752

(22) PCT Filed: Mar. 15, 2012
(86) PCT No.: PCT/US2012/029163

§ 371 Date: Sep. 12, 2014

(51) Int. Cl. G06F 1/16

(52) U.S. Cl. CPC G06F 1/1626; G06F 1/1632

(57) ABSTRACT

The system or method can include a first housing and a second housing. A mass storage device can be in the second housing. The mass storage device may be connected to a network.

### BACKGROUND

A tablet computer includes a touch screen as the primary form of input rather than a keyboard. A tablet may include a virtual keyboard image that is display in the touch screen. The alpha numeric input is done using the virtual keyboard on the touch screen. A tablet is often held by a user while operating causing a user to want a thin and light tablet computer.

### BRIEF DESCRIPTION OF THE DRAWINGS

Some embodiments of the invention are described with respect to the following figures:

FIG. 1 is a block diagram of computing system including a first and a second housing according to an example implementation;

FIG. 2 is a block diagram of computing system including a first and a second housing according to an example implementation;

FIG. 3 is a flow diagram of a method of connecting a computing device in a first housing to a mass storage device in a second housing according to an example implementation;

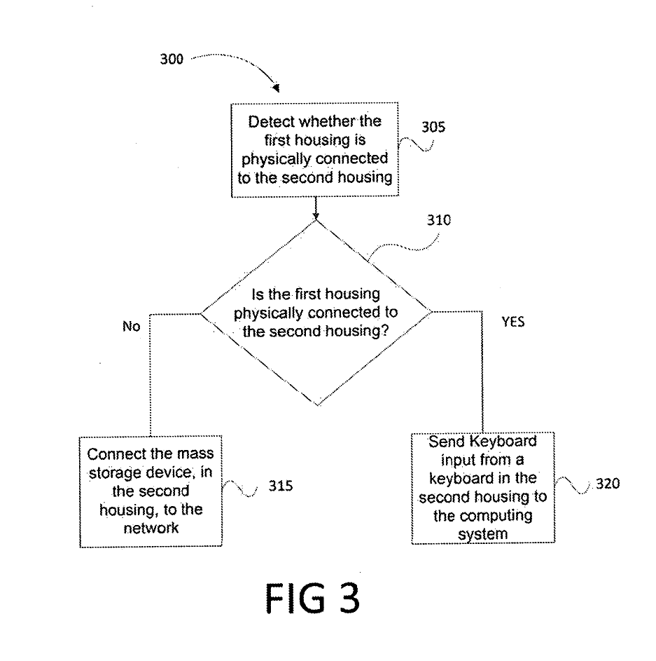

FIG. 4 is a flow diagram of a method of connecting a computing device in a first housing to a mass storage device in a second housing according to an example implementation; and

FIG. 5 is a computing system including a computer readable medium according to an example implementation.

### DETAILED DESCRIPTION

A tablet computer, which may also be called a slate computer, does not have a physical keyboard like a laptop. A tablet computer is often thinner and lighter than a notebook computer with a keyboard since it forgoes the keyboard and base to enclose the keyboard. A tablet computer can be used by holding the tablet computer with one or two hands and therefore maybe thinner and lighter than a notebook computer.

A notebook computer often includes a hard drive and a battery in the base of the notebook however a tablet may not include a hard drive due to the size of the hard drive, the power capacity of the battery in the tablet, or the weight of the hard drive. Tablets may use a solid state non-volatile memory such as flash memory. Flash memory may be for example 32, 64, 128 or more gigabytes, but hard drives may be 1 terabyte or more and cost significantly less.

A tablet computer may be compatible with a docking station including a keyboard. The keyboard may make the input for the tablet similar to that of a notebook or desktop computer. To increase storage for the tablet a mass storage device such as a hard drive can be added to the docking station. The tablet may communicate with the mass storage device through an electrical, optical or other physical connection. If the table computer is removed from the docking station the tablet is more portable however loses the physical connection to the mass storage in the docking station. The mass storage can be connected to a network such as an intranet or the internet. The tablet can also connect to the network and communicate with the mass storage in the docking station when not connected to the docking station.

In one embodiment, a computing system can include a first housing and a second housing. The first housing can include a display device. The second housing can removably connect to the first housing. A mass storage device can be in the second housing. A controller in the second housing can be connected to the mass storage device. A transceiver in the second housing can connect to a network. A memory in the second housing can include an embedded operating system to connect the mass storage device to a network.

One embodiment can be a method of connecting a computing device in a first housing to a mass storage device in a second housing. The method can include detecting whether the first housing is physically connected to the second housing. If the first housing is not physically connected to the second housing the mass storage device can be connected to the network. If the first housing and the second housing are physically connected a keyboard can send keyboard input in the second housing to the computing system in the first housing.

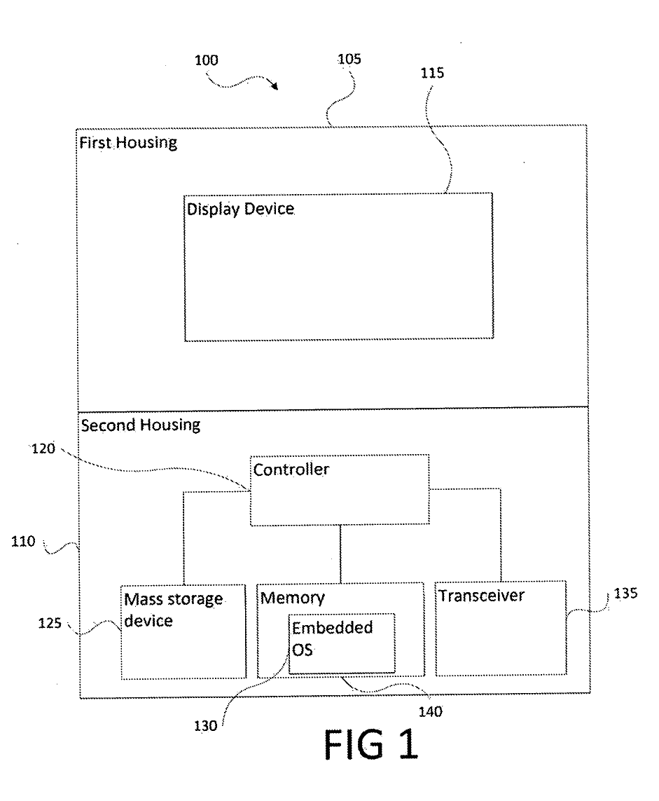

With reference to the figures, FIG. 1 is a block diagram of computing system including a first and a second housing according to an example implementation. The computing system 100 can include a first housing 105 and a second housing 110. The first housing 100 can include a display device 115. The first housing may include a computing device and the display device 115 may be a touch screen for input to the computing device.

The second housing 110 can removably connect to the first housing 105. The second housing 110 if connected to the first housing 105 may resemble a notebook computer or an all in one desktop computer. If the second housing 110 is separate from the first housing 105 the first housing may resemble a tablet computing device.

A mass storage device 125 can be in the second housing 110. The mass storage device may be for example a hard disk drive, a solid state drive (SSD), an optical drive, or another mass storage drive. A controller 120 in the second housing 110 can be connected to the mass storage device 125. To provide access to the mass storage device 125 from the computing device of the first housing 105.

A transceiver 135 in the second housing 110 can connect to a network. The transceiver may be for communicating with a network such as the access point of an Ethernet network, a wireless fidelity (wifi) network, or another network.

A memory 140 in the second housing can include an embedded operating system 130 to connect the mass storage device 125 to a network. The embedded operating system 130 may be executed by the controller. The embedded operating system 130 can identify the mass storage device on the network, authenticate the network, provide security such as encryption of the hard drive or network communication, create a virtual private network, or other mass storage or network connection related tasks. An embedded operating system is designed to leave out some foundational software used to support the wide variety of applications that non-embedded computer operating systems provide and provide the foundational software used by the specialized applications managed by the embedded operating system. An embedded operating system may include an application and the operating system statically linked together into a single executable image. The embedded operating system does not load and execute applications therefore the controller executing the embedded operating system may be able to run a single application linked to the operating system. The application and the embedded OS can function to connect the computing device of the first housing 105 to the mass storage device of the second housing if the first housing is connected to the second housing and to connect the mass storage device to a network for access by the computing device in the first housing if the first housing is not connected to the second housing.

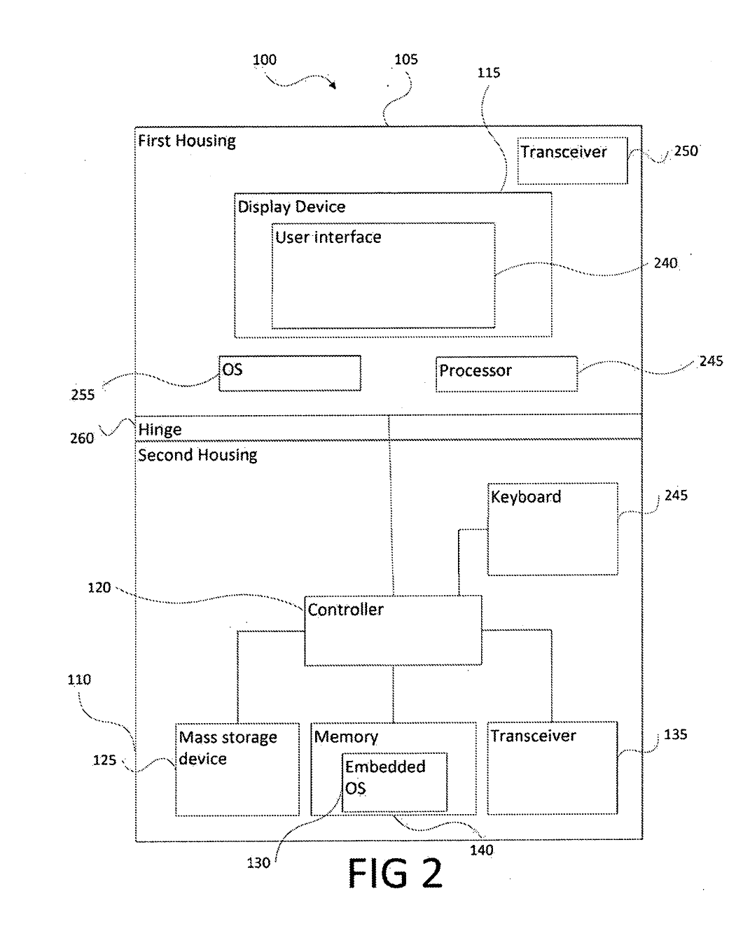

FIG. 2 is a block diagram of computing system including a first and a second housing according to an example implementation. The embedded operating system 140 may not have a user interface. For example the embedded operating system may have been preprogrammed to connect to the computing system in the first housing 105. In another implementation the embedded operating system may provide a user interface 240 on the display device 115 of the computing device in the first housing 105. The user interface 240 may be to change network settings or mass storage related settings.

In one implementation, the embedded operating system may not execute software that is not related to connecting a computing device to the mass storage device. Connecting the computing device to the mass storage device may include connecting the mass storage device to a network.

The computing device of the first housing may include a processor 245 and a full operating system 255 in the first housing 105. The processor 245 may be a single or multicore processor to execute a full operating system 255. A full operating system can run many different type of software which can be installed and loaded by the operating system when called for. For example a full operating system may be able to run a word processing application, a spread sheet application, an internet browser or another type of application because the full operating system is not tied to a specific application.

If the first housing is connected to the second housing the mass storage device may be connected to the computing system through a non-wireless connection. For example the first housing may be connected through an electrical conductor, an optical connection or another non-wireless connection. An example may be a universal serial bus protocol connection, a thunder bolt port connection or another type of connection. In one implementation the transceiver to connect the mass storage device to the network may be disconnected from the network. For example if the transceiver is a wireless transceiver the transceiver may be turned off to save power or to turn off the wireless connection to the network on a plane.

If the first housing is not connected to the second housing the mass storage device can be connected to the computing system through a wireless connection. The transceiver 135 may create an access point for the transceiver 250 in the First housing 105 to connect to or the transceiver 135 may connect to a network such as through an Ethernet or wireless access point. The computing system in the first housing 105 can connect to the mass storage device through the network such as an intranet, the internet or another network to allow the computing device of the first housing to access data stored on the mass storage device whether connected to the device or located in remotely as long as they were connected to the same network. The controller 120 and the computing device of the first housing 105 may create a virtual private network through the internet for example to secure the data as it is access on the mass storage device by the computing device of the first housing 105.

The second housing 110 may include a keyboard 245. The keyboard can be a QWERTY keyboard or another language keyboard. If the first housing is attached to the second housing the keyboard can be used as an input device for the computing system in the first housing 105. In one implementation the keyboard is a virtual keyboard image on a display in the second housing. If the second housing 110 includes a display the images on the display may be generated by at least one of the computing system in the first housing 105, the controller in the second housing 110 or another controller.

The computing system 100 may include a hinge to allow the first housing 105 to pivot relative to the second housing 110 if the first housing 105 is connected to the second housing 110. In one implementation the display device of the first housing can be projected by the second housing if the first housing is rotated at the hinge so that the display device 115 is facing the keyboard 245 of the second housing. [MT: I'm not sure what “projected by the second housing” is meant to convey]

FIG. 8 is a flow diagram of a method 300 of connecting a computing device in a first housing to a mass storage device in a second housing according to an example implementation. The method 300 can include detecting whether the first housing is physically connected to the second housing at 305. Detecting whether the two housing are connected may be though a sensor such as a reed switch or an electrical signal if the first housing and the second housing are electrically connected.

A decision is made at 310 if the first housing is physically connected to the second housing go to 320 and the first housing is not physically connected to the second housing go to 315. If the first housing is not physically connected to the second housing the mass storage device can be connected to the network at 315. For example a transceiver can be used to connect to an intranet, the internet or another network allowing the mass storage device to be accessible through the network. If the first housing and the second housing are physically connected a keyboard can send Keyboard input in the second housing to the computing system in the first housing at 320.

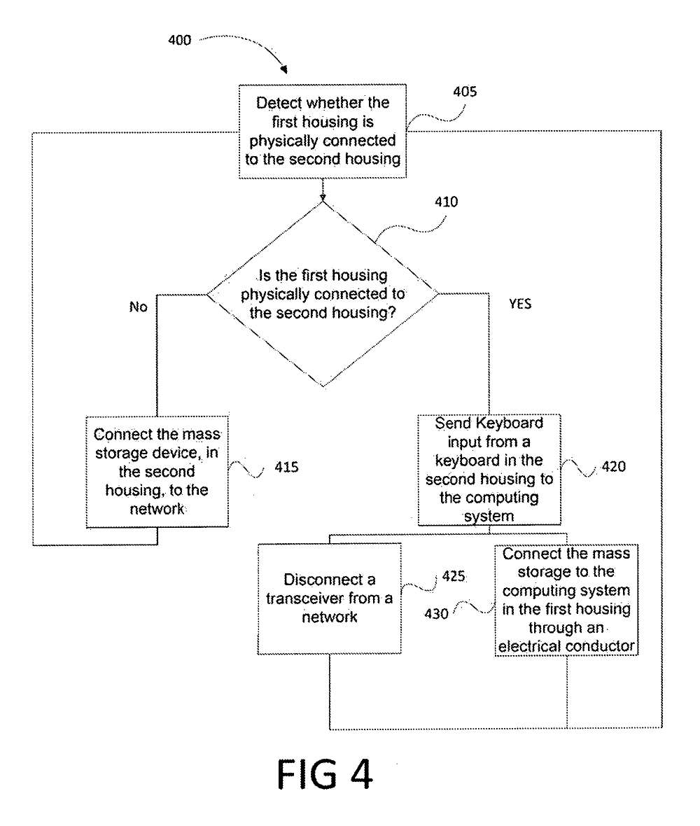

FIG. 4 is a flow diagram of a method 400 of connecting a computing device in a first housing to a mass storage device in a second housing according to an example implementation. The method 400 can include detecting whether the first housing is physically connected to the second housing at 405. Detecting whether the two housing are connected may be though a sensor such as a reed switch or an electrical signal if the first housing and the second housing are electrically connected.

A decision is made at 410 if the first housing is physically connected to the second housing go to 420 and the first housing is not physically connected to the second housing go to 415. If the first housing is not physically connected to the second housing the mass storage device can be connected to the network at 415. For example a transceiver can be used to connect to an intranet, the internet or another network allowing the mass storage device to be accessible through the network. If the first housing and the second housing are physically connected a keyboard can send keyboard input in the second housing to the computing system in the first housing at 420.

The method 400 may include disconnecting a transceiver from a network at 425. A controller may disconnect the mass storage device from the network if they first housing and second housing are connected for security reasons such as there may be no reason to allow network access to the mass storage if the computing system is connected to the second housing. The controller may turn off a wireless transceiver when the two housing are connected such as on an airplane where wireless is not used. The mass storage can be connected to the computing system in the first housing through an electrical conductor at 430 is may result in the transceiver being disconnected from the network in 425.

The method of 300 and the method 400 may provide connection of the mass storage device by a controller executing an embedded operating system for connecting the mass storage device to the network.

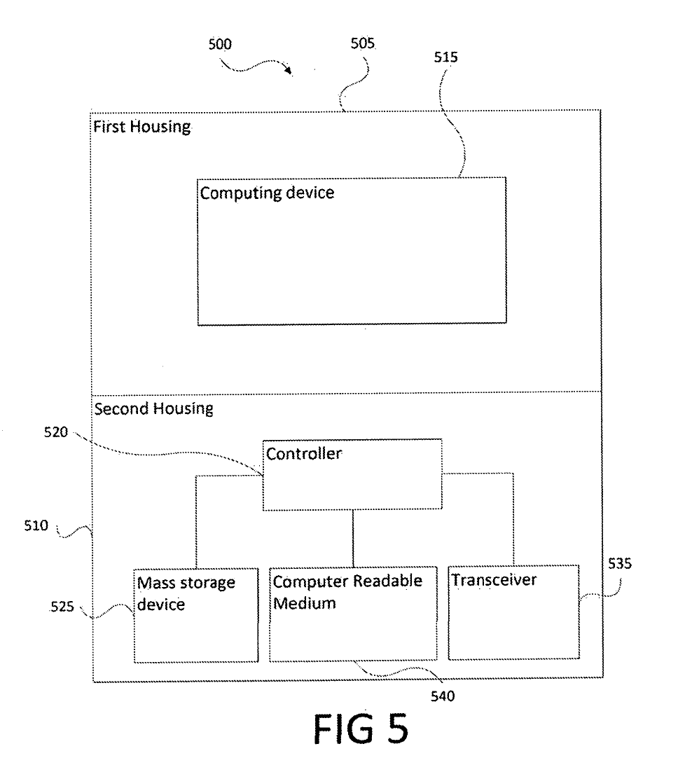

FIG. 5 is a computing system 500 including a computer readable medium according to an example implementation. The computing system can include a computing device 515 in the first housing 515 and the computing system can include a second housing 510. A computer readable medium 540 in a second housing can include code that if executed by a controller 520 in a second housing 510 causes a controller 520 to detect whether a first housing 505 including a computing device is physically connected to the second housing 510. The code may cause the controller to disconnect the mass storage device 525 in the second housing 510 from a network if the first housing 505 is physically connected to the second housing 510 and connect the mass storage device 525 in the second housing 510 to the network if the first housing it not physically connected to the second housing.

The code on the computer readable medium 540 may cause the controller to disconnect a transceiver 535 from a network when disconnecting the mass storage 525 from the network. To disconnect the mass storage device from the network the controller may disconnect the transceiver 535 from the network. The controller may disconnect the mass storage device from the transceiver to allow the transceiver to remain connected to the network.

The techniques described above may be embodied in a computer-readable medium for configuring a computing system to execute the method. The computer readable media may include, for example and without limitation, any number of the following: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc.; and the Internet, just to name a few. Other new and various types of computer-readable media may be used to store the software modules discussed herein. Computing systems may be found in many forms including but not limited to mainframes, minicomputers, servers, workstations, personal computers, notepads, personal digital assistants, various wireless devices and embedded systems, just to name a few.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A computing system comprising:
a first housing including a display device;
a second housing to removably connect to the first housing;
a mass storage device in the Second housing;
a controller in the second housing connected to the mass storage device;
a transceiver in the second housing to connect to a network; and
a memory including an embedded operating system to connect the mass storage device to a network.

2. The system of claim 1, wherein the embedded operating system does not have a user interface to display.

3. The system of claim 1, wherein the embedded operating system uses the user interface on the display of the computing system to change network settings.

4. The system of claim 1, wherein the mass storage device is connected to the computing system through a non-wireless connection if the first housing is connected to the second housing.

5. The system of claim 4, wherein the mass storage device is connected to the computing system through a wireless connection if the first housing is not connected to the second housing.

6. The system of claim 1, further comprising a keyboard in the second housing.

7. The system of claim 1, further comprising a processor and a full operating system in the first housing.

8. The system of claim 1, wherein the embedded operating system does not execute software that is not related to connecting a computing system to the mass storage device.

9. The system of claim 1, further comprising a transceiver in the first housing to connect the computing system to the network.

10. The system of claim 1, further comprising a hinge to allow the first housing to pivot relative to the second housing if the first housing is connected to the second housing.

11. A method of connecting a computing device in a first housing to a mass storage device in a second housing comprising:
detecting whether the first housing is physically connected to the second housing;
connecting the mass storage device, in the second housing, to the network if the first housing is not physically connected to the second housing; and
sending keyboard input in the second housing to the computing system in the first housing if the first housing and the second housing are physically connected.

12. The method of claim 11, further comprising disconnecting a transceiver from a network and connecting the mass storage to the computing device in the first housing through an electrical conductor.

13. The method of claim 11, wherein connection of the mass storage device is done by a controller executing an embedded operating system for connecting the mass storage device to the network.

14. A computer readable medium in a second housing comprising code that if executed by a controller in a second housing causes a controller to:
detect whether a first housing including a computing device is physically connected to the second housing;
disconnect the mass storage device, in the second housing, from a network if the first housing is physically connected to the second housing; and
connect the mass storage device, in the second housing, to the network if the first housing is not physically connected to the second housing.

15. The computer readable medium of claim 14 further comprising code that if executed causes a computing device to:
disconnect a transceiver from a network when disconnecting the mass storage from the network.
